(19) United States
(12) Patent Application Publication
(10) Pub. No.: US 2011/0259847 A1
(43) Pub. Date: Oct. 27, 2011

(54) BOTTLE PACKAGING FOR FLOWABLE PRODUCT

(75) Inventors: Christopher A. Cox, Westerville, OH (US); Terrence B. Mazer, New Albany, OH (US); Thomas D. Loughrin, Columbus, OH (US)

(73) Assignee: ABBOTT LABORATORIES, Abbott Park, IL (US)

(21) Appl. No.: 13/082,531

(22) Filed: Apr. 8, 2011

Related U.S. Application Data
(60) Provisional application No. 61/322,146, filed on Apr. 8, 2010.

(51) Int. Cl. B67D 3/00; B65D 41/16; B65D 53/02; B65D 41/04

(52) U.S. Cl. 215/391; 222/527; 215/329; 220/795

(57) ABSTRACT

A bottle packaging includes a groove on the neck of a bottle with the groove spaced longitudinally from a shoulder of the bottle a distance greater than or equal to a width of the groove, and upper and lower portions of the neck may have outer transverse cross-sectional dimensions that are substantially equal to one another. An upper circumferential sidewall of the groove may be chamfered, while a lower circumferential sidewall may be concave. The bottle may be combined with an adapter such that when the adapter is releasably connected to the bottle, a lowermost rim of the adapter is spaced longitudinally from an upper reach of the groove. The adapter may include a detent on an inner surface thereof adapted to removably seat in the groove to releasably connect the adapter to the bottle. A closure member may include at least one of a detent and a sealing member removably seated in the groove.

### CROSS REFERENCE TO RELATED APPLICATION

This application claims the benefit of U.S. Provisional Application No. 61/322,146 filed Apr. 8, 2010, which disclosure is incorporated by reference in its entirety.

### BACKGROUND

The field of the invention relates generally to bottle packaging for a flowable product, as well as such bottle packaging that is useful in combination with a feeding delivery assembly.

Automated foodstuff processing and filling apparatus are used to quickly and efficiently sterilize bottles and fill the sterilized bottles with a food product. Typically, a conveyor element of the filling apparatus moves the bottles in a machine direction between stations of the apparatus. One such bottling apparatus, for example, is described in U.S. Pat. No. 6,748,983. This bottling apparatus has a frame and an endless conveyor element on the frame carrying a plurality of holder plates each formed with a row of seats adapted to fit snugly around necks of bottles. Each bottle includes a circumscribing rib or ring projecting radially outward from the neck of the bottle for engaging the seat formed by the holder plates to allow the bottle to be transported along the machine direction of the filling apparatus.

Such a rib or projecting ring can in certain circumstances be a hindrance or an inconvenience. As but one example of a number of such circumstances, some packaged foodstuffs such as nutritional or medical foodstuffs are used for delivery to a person in need thereof by enteral delivery. The bottles in which the foodstuff is packaged are configured for interchangeability between the bottle closure or cap and a feeding tube or delivery assembly. In particular, the bottles typically have a threaded finish, and the delivery assembly includes an adapter that can be threaded onto the bottle in place of the bottle closure. Suitably tubing and other delivery assembly components are assembled with the adapter so that foodstuff can be delivered from the bottle through the delivery assembly tubing to the person in need of such foodstuff.

As the adapter is threaded onto the bottle, the lowermost rim of the adapter moves increasingly closer to the projecting ring. As the gap therebetween decreases, a finger of the caregiver or other person connecting the delivery assembly to the bottle can be pinched between the adapter the projecting ring. In other instances, the projecting ring can also make it more burdensome to assemble the bottle with a bottle holder, such as holding bag in which the neck of the bottle must be inserted through a relatively small opening in the holding bag.

### SUMMARY

In one aspect, a bottle packaging generally comprises a bottle and a closure member. The body generally comprises a body having an upper end and a closed lower end, a shoulder disposed generally at the upper end of the body, and a neck extending up from the shoulder and defining an open top of the bottle. The neck has an inner surface, an outer surface and a groove in the outer surface of the neck. The groove extends circumferentially about substantially an entire circumference of the neck and is disposed longitudinally intermediate the shoulder of the bottle and the open top of the bottle. The groove has an upper reach and a lower reach and a width extending between the upper and lower reaches. The lower reach of the groove is longitudinally spaced from the shoulder of the bottle a distance of greater than or equal to the width of the groove. The neck includes a lower portion extending from the lower reach of the groove to the shoulder of the bottle, and an upper portion extending from the open top of the bottle to the upper reach of the groove. The upper and lower portions of the neck each have an outer transverse cross-sectional dimension. The outer transverse cross-sectional dimension of the upper portion is substantially equal to the outer transverse cross-sectional dimension of the lower portion. The closure member is releasably connectable with the neck of the bottle to close the open top of the bottle.

In another aspect, a bottle packaging generally comprises a bottle and a closure member. The bottle generally comprises a body having an upper end and a closed lower end, a shoulder disposed generally at the upper end of the body, and a neck extending up from the shoulder and defining an open top of the bottle. The neck has an inner surface, an outer surface and a groove in the outer surface of the neck. The groove extends circumferentially about substantially an entire circumference of the neck and is disposed longitudinally intermediate the shoulder of the bottle and the open top of the bottle. The groove is defined by a circumferential floor and opposing upper and lower circumferential sidewalls. The upper circumferential sidewall is chamfered from adjacent the outer surface of the neck toward the circumferential floor. The lower circumferential sidewall is concave from adjacent the outer surface of the neck toward the circumferential floor. The lower circumferential sidewall is spaced longitudinally above the shoulder a distance of at least about 1.0 mm. The closure member is releasably connectable with the neck of the bottle to close the open top of the bottle.

In yet another aspect, a flowable product delivery assembly generally comprises a bottle and an adapter. The bottle has a longitudinal axis and generally includes a neck having an outer surface and a groove in said outer surface extending circumferentially around substantially an entire circumference of the neck. The groove has an upper reach and a lower reach. The adapter is removably connected to the neck of the bottle by a threaded connection to fluidly connect the bottle to tubing. The adapter includes a lowermost rim spaced longitudinally from the upper reach of the groove.

In another aspect, a flowable product delivery assembly generally comprises a bottle and an adapter. The bottle has a longitudinal axis and a neck having an outer surface and a groove in the outer surface extending circumferentially around substantially an entire circumference of the neck. The adapter is configured for releasable connection to the bottle to fluidly connect the bottle to tubing. The adapter includes a detent on an inner surface thereof adapted to removably seat in the groove to releasably connect the adapter to the bottle.

In yet another aspect, a bottle packaging generally comprises a bottle and a closure member. The bottle generally comprises a body having an upper end and a closed lower end, a shoulder disposed generally at the upper end of the body, and a neck extending up from the shoulder and defining an open top of the bottle. The neck has an inner surface, an outer surface, at least one thread on the outer surface of the neck, and a groove in the outer surface of the neck. The groove extends circumferentially about substantially an entire circumference of the neck and is disposed longitudinally intermediate the shoulder of the bottle and the at least one thread on the outer surface of the neck. The closure member is removably threaded on the at least one thread on the outer surface of the neck of the bottle to close the open top of the bottle. The closure member includes at least one of a detent and a sealing member removably seated in the groove of the neck of the bottle.

### BRIEF DESCRIPTION OF THE DRAWINGS

FIG. 1 is a front elevation of a first embodiment of bottle packaging;

FIG. 2 is a fragmented section taken along the line 2-2 in

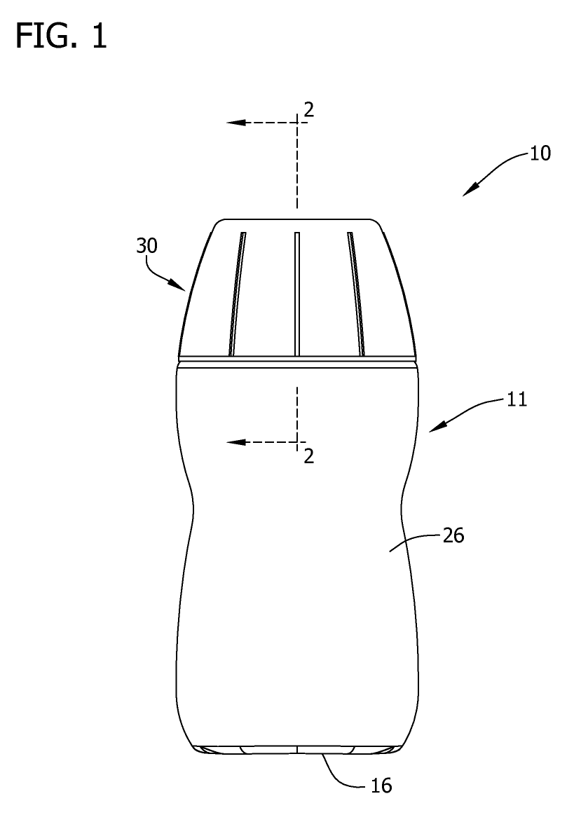

FIG. 1;

FIG. 3 is a front perspective of the bottle packaging of FIG. 1 with a cap and a seal closure removed therefrom;

FIG. 4 is a front elevation of the bottle packaging of FIG. 3;

FIG. 5 is an enlarged fragmented view of the bottle packaging of FIG. 4;

FIG. 6 is a fragmented front elevation of the bottle packaging of FIG. 3 having a tubing set connected thereto;

FIG. 7 is longitudinal section of the bottle packaging and a first embodiment of a tubing adapter of the tubing set of FIG. 6 connected thereto;

FIG. 8 is a front elevation of a first embodiment of a holder for the bottle packaging;

FIG. 9 is a front elevation of a first embodiment of a flowable product delivery assembly hanging on an elevated support, the assembly including the bottle packaging and tubing set of FIG. 6 and the holder of FIG. 8;

FIG. 10 is a front perspective of a second embodiment of a flowable product delivery assembly hanging on an elevated support, the assembly including the bottle packaging and tubing set of FIG. 6 and a second embodiment of a holder;

FIG. 11 is a fragmented longitudinal section of a second embodiment of bottle packaging;

FIG. 12 is a fragmented longitudinal section of the bottle packaging of FIG. 11 with a second embodiment of a tubing adapter connected thereto;

FIG. 13 is a fragmented longitudinal section of a third embodiment of bottle packaging; and

FIG. 14 is a fragmented longitudinal section of a fourth embodiment of bottle packaging.

Corresponding reference characters indicate corresponding parts throughout the several views of the drawings.

### DETAILED DESCRIPTION OF THE DRAWINGS

Referring now to the drawings and in particular to FIGS. 1-5, a first embodiment of bottle packaging is generally indicated at 10. The bottle packaging 10 is configured for holding a quantity of flowable product, and for delivering the flowable product to a consumer and/or user. The flowable product may include nutritional or medical product for adult or pediatric nutrition, including but not limited to the following: fat; protein; carbohydrates; minerals; vitamins; probiotics; prebiotics; nutrients; compounds or concentrates that aid in digestion, nutrition, or improvement in physical health; complete or modular nutrition that aids in metabolism or alters how metabolism occurs; and other dietary supplements. The bottle packaging 10 may be aseptically or terminally sterilized.

The bottle packaging 10 broadly comprises a bottle, generally indicated at 11, and a cap, generally indicated at 30, that is releasably connectable to the bottle and broadly defines a closure for the bottle. With reference to FIG. 3, the bottle 11 generally comprises a body 26 having an upper end and a closed lower end 16, a shoulder 24 disposed generally at the upper end of the body, and a neck 22 extending up from the shoulder and defining a top or lip 12 of the bottle defining an opening 14. The bottle 11 has a longitudinal axis L extending between the open top 12 of the bottle and the closed end 16 of the body 26. In one embodiment, the bottle 11 may have a suitable volume of about 1 ml to about 2000 ml, or more suitably, about 50 ml to about 500 ml. The illustrated body 26 is generally hour-glass shaped, although the body may be of another suitable shape. The shoulder 24 extends transversely outward and downward from the neck, although the shoulder may alternatively extend transversely outward from the neck 22 without a downward taper and remain within the scope of the present invention. In general, the bottle packaging 10 may have other shapes and sizes without departing from the scope of the present invention.

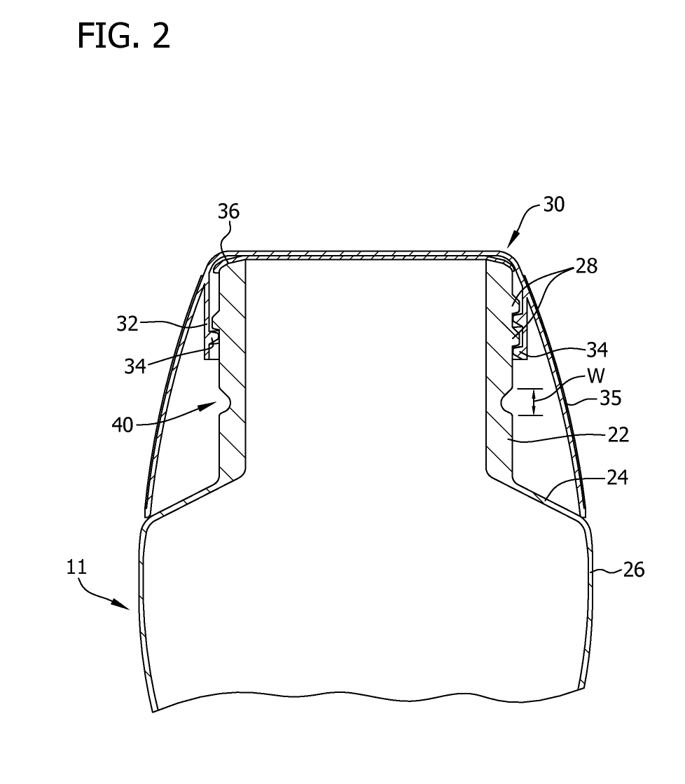

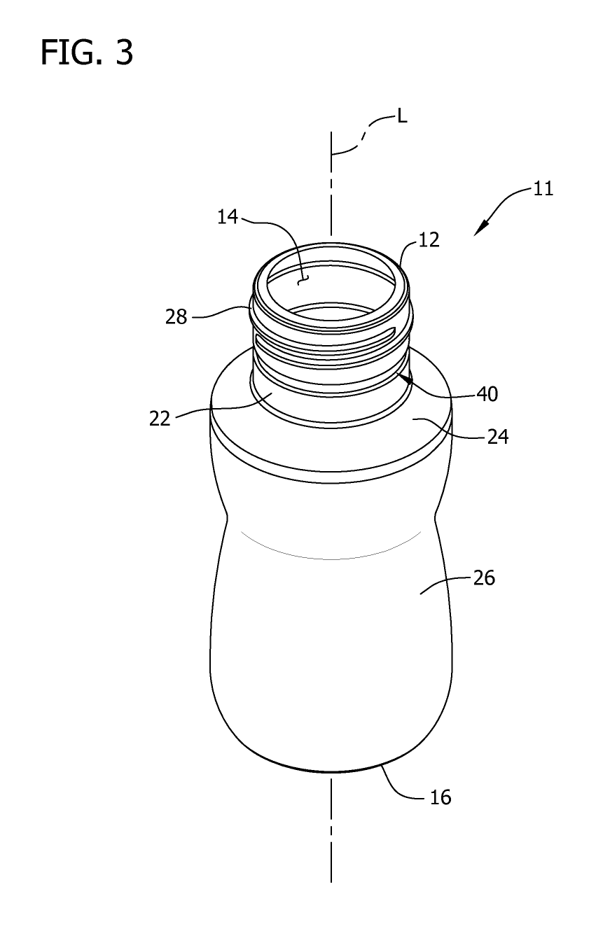

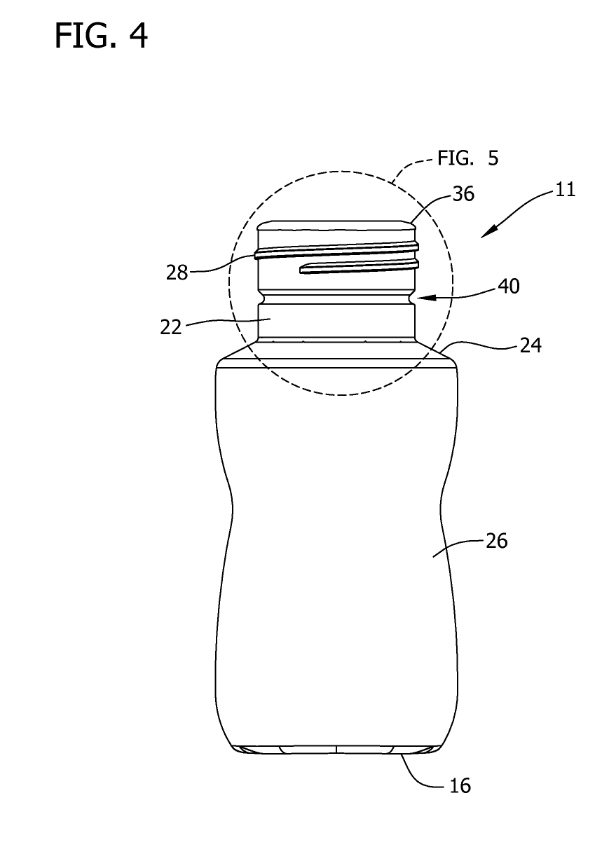

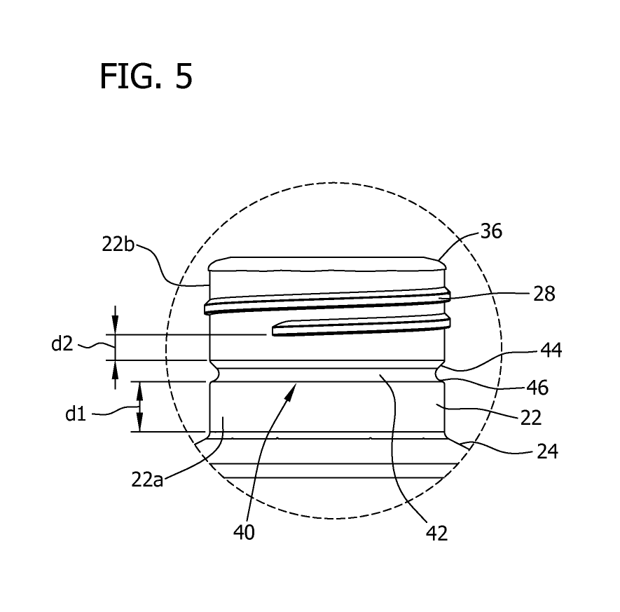

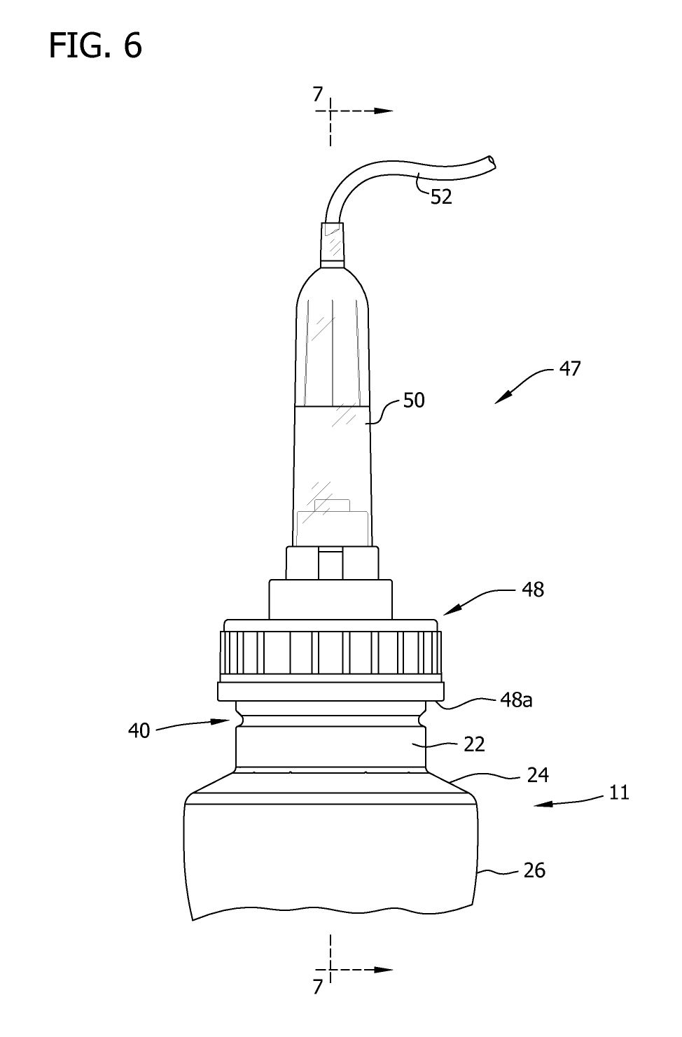

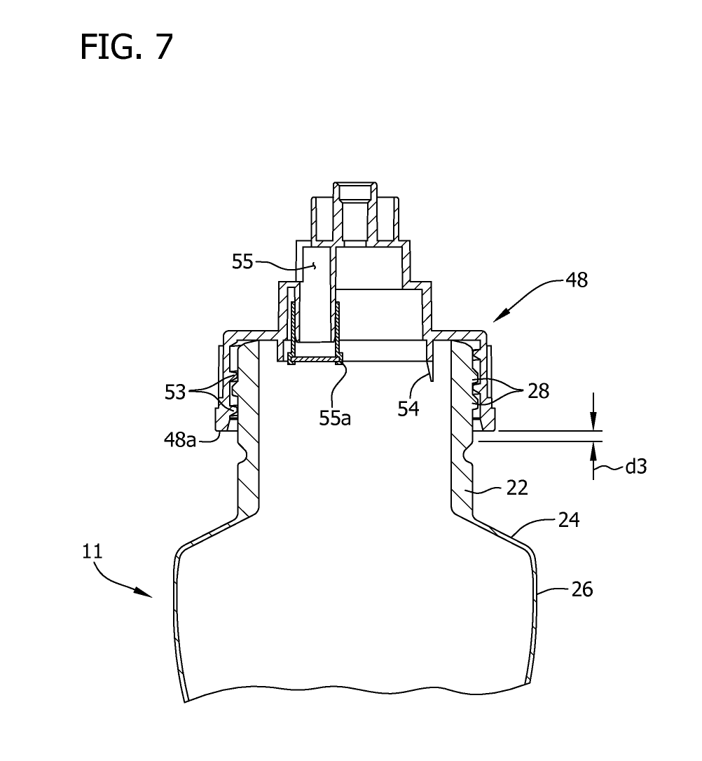

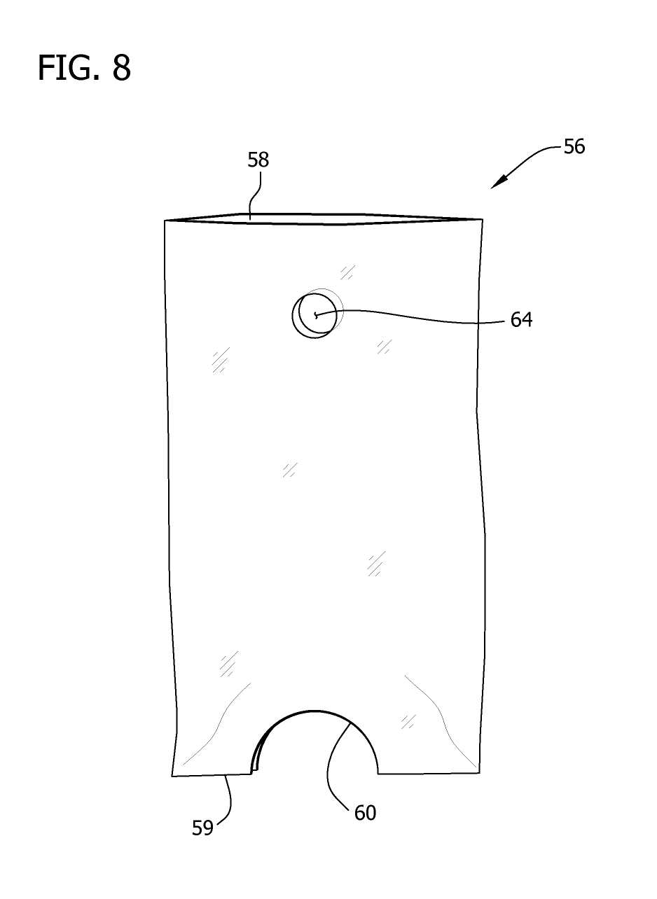

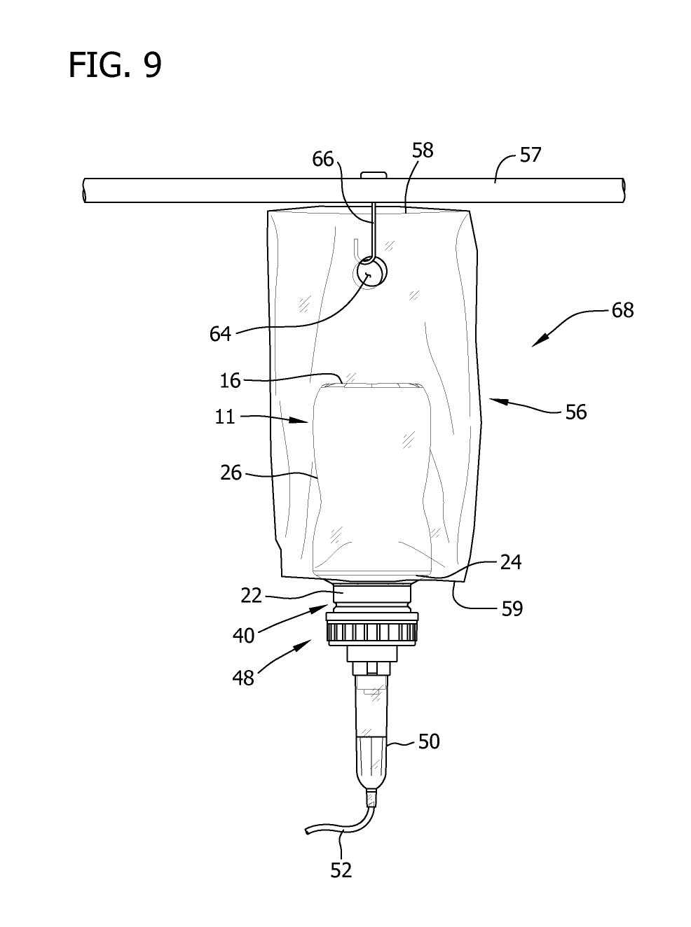

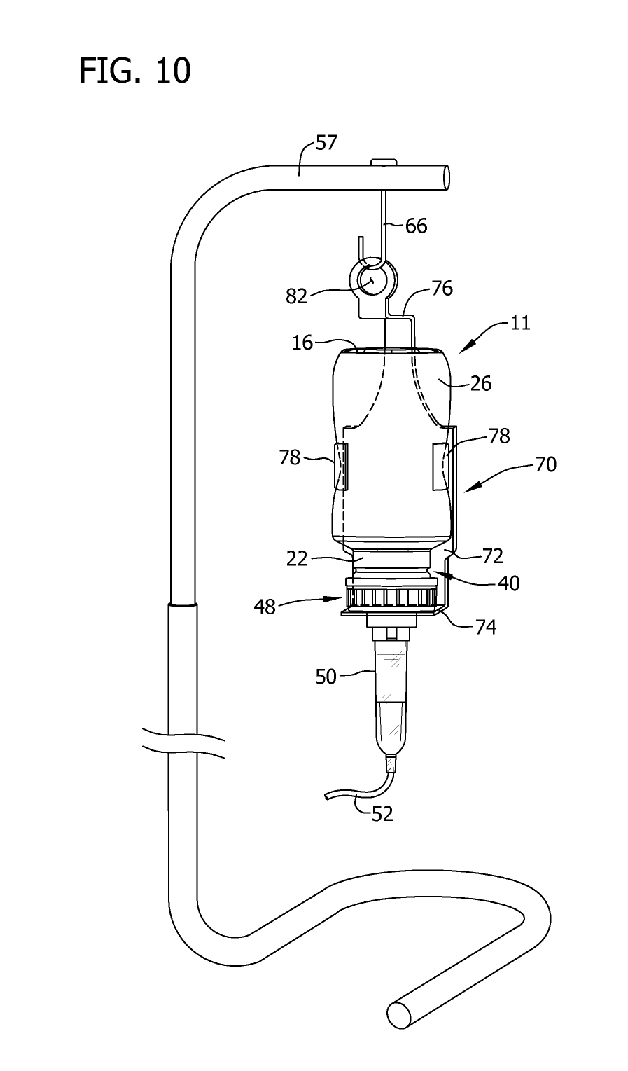

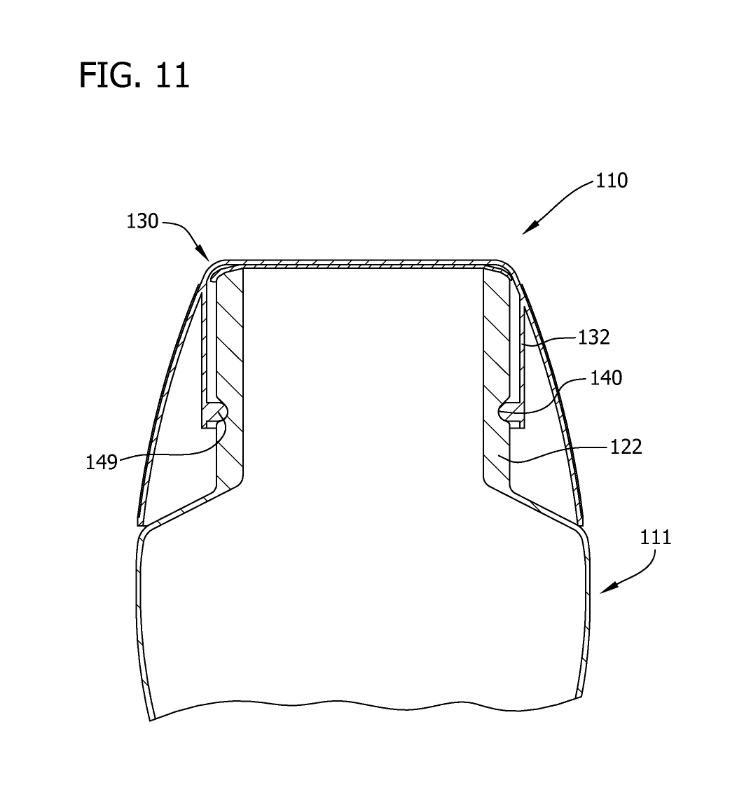

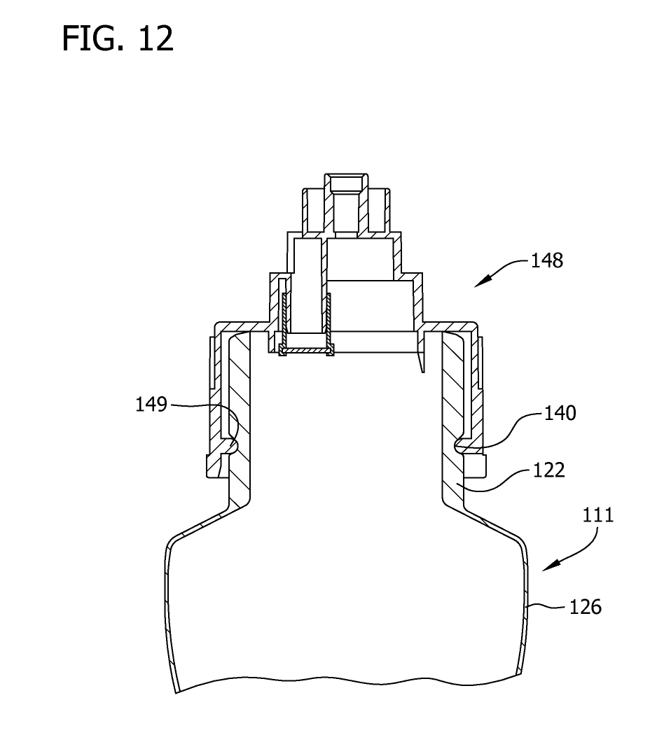

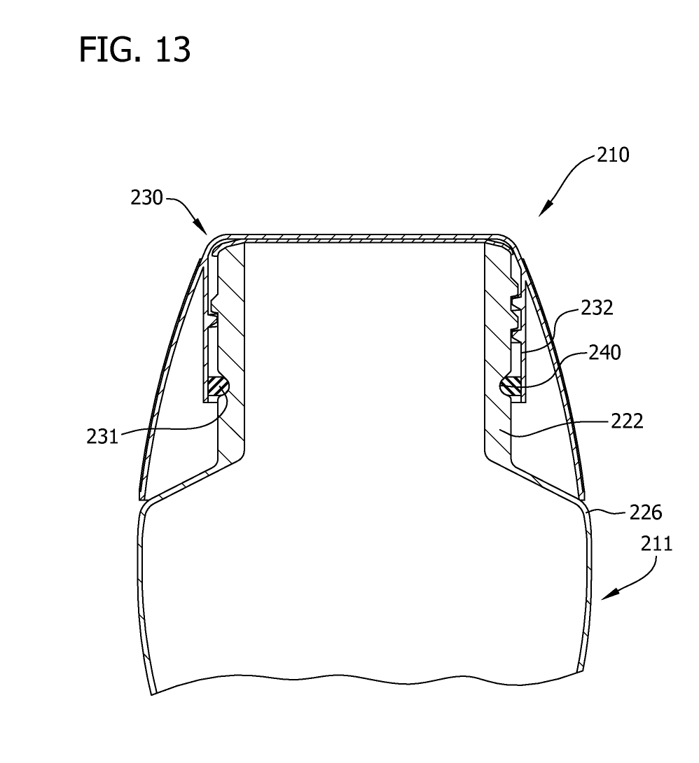

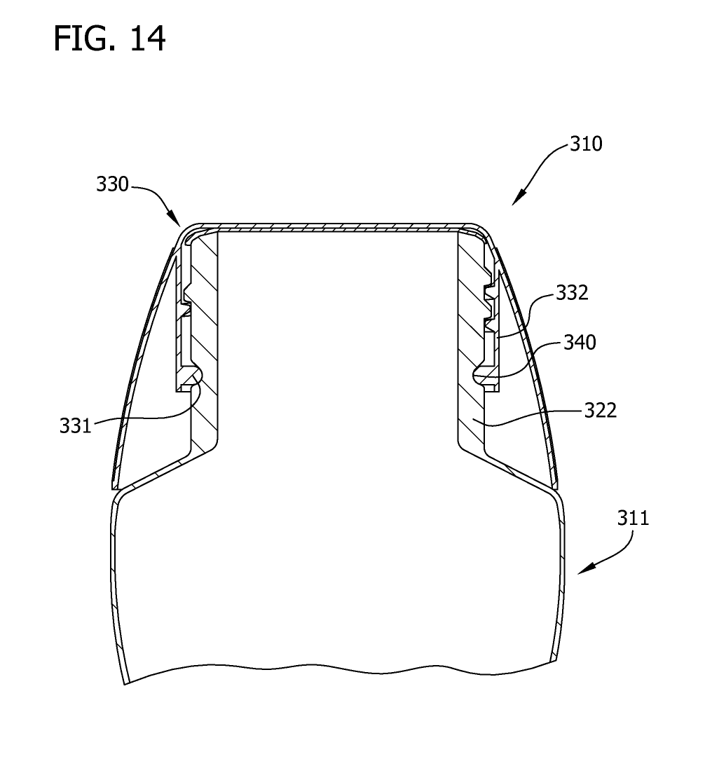

Referring to FIGS. 1-2, the neck 22 includes one or more external threads 28, such as a continuous thread, for releasably connecting the cap 30 to the bottle 11. The thread 28 can be left-handed or right-handed. The illustrated cap 30 comprises a securement component 32, including one or more threads 34 that mate with the external threads 28 on the neck 22. Referring to FIG. 2, an outer skirt or shroud 35 of the cap 30 surrounds the securement component 32 and extends to and abuts the shoulder 24 of the bottle 11 when the cap 30 is secured to the bottle 11. A seal closure 36, such as an aluminum foil seal, is secured to the lip 12 of the bottle 11 and extends over the opening 14 upon initial packaging of the bottle. The seal closure 36 may be secured to the lip 12 such as by adhesive or heat-sealing or by other suitable means. The seal closure 36 is suitably puncturable and/or removable from the lip 12 to allow access to the product packaged within the bottle 11. It is understood that in some embodiments the bottle packaging 10 may omit the cap 30 and/or the seal closure 36 without departing from the scope of the present invention. It is also understood that the cap 30 may be configured other than as illustrated and remain within the scope of this invention.

As seen best in FIGS. 4 and 5, the neck 22 of the bottle 11 has a groove, generally indicated at 40, formed in the outer surface of the neck. The illustrated groove 40 suitably extends circumferentially around an entire circumference of the neck 22. Referring to FIG. 5, the groove 40 is defined at least in part by a circumferential floor 42 and opposed upper and lower circumferential sidewalls 44, 46, respectively, extending between the floor and the outer surface of the neck 22. The groove 40 in one embodiment is sized and shaped to allow a gripping device of an automated bottle filler machine to fit within the groove so that the bottle 11 can be transported along a processing and filling line. For example, one such gripping device (not shown) includes opposing plates with semicircular cutouts. When the bottle 11 is disposed between the plates, the plates are moved toward one another so that the plates enter and seat within the groove 40 to grip and carry the bottle. To release the bottle 11, the plates are separated from one another.

In the illustrated embodiment, the outer surface of the neck 22, which is considered separate from the threads 28 and the groove 40 of the neck, has a substantially uniform cross-sectional dimension along the longitudinal axis L. The neck 22 includes a lower portion 22a (FIG. 5) extending from the lower circumferential sidewall 44 of the groove 40 (i.e., a lower reach thereof) to the shoulder 24 of the bottle 11 and an upper portion 22b (FIG. 5) extending from the open top of the bottle to the upper circumferential sidewall 46 of the groove (i.e., an upper reach thereof). The lower and upper portions 22a, 22b of the neck 22 have outer transverse cross-sectional dimensions that are substantially equal. In the illustrated embodiment, for example, the outer diameters of the lower and upper portions 22a, 22b are substantially equal. It is understood that the outer surface of the neck 22 may not have a uniform transverse cross-sectional dimension along the longitudinal axis L and remain within the scope of the present invention.

Referring still to FIG. 5, the lower circumferential sidewall 46 of the groove 40 is generally arcuate and more suitably concave from the outer surface of the neck 22 toward the circumferential floor 42. The outer corner formed where the lower circumferential sidewall 46 adjoins the outer surface of the neck 22 may be radiused (i.e., rounded), as illustrated. In other embodiments, the lower circumferential sidewall 46 may alternatively be configured other than concave and may be other than arcuate. The upper circumferential sidewall 44 in the illustrated embodiment is chamfered, meaning that when the sidewall is viewed in cross section, as in FIG. 5, the upper circumferential sidewall extends linearly (i.e., straight, non-curved) upward from the floor 42 at an angle relative to the longitudinal axis L. It is understood that in some embodiments, the upper circumferential sidewalls 44 may be generally convex (i.e., rounded) or may be concave without departing from the scope of the present invention. In the illustrated embodiment, the circumferential outer corner formed where the chamfered upper circumferential sidewall 44 adjoins the outer surface of the upper portion 22b of the neck 22 may be radiused (i.e., rounded), as illustrated, and the segment along which the chamfered upper circumferential sidewall adjoins the circumferential floor 42 may be filleted, as illustrated.

In the illustrated embodiment, the groove 40 has a uniform width W (FIG. 2) extending between the circumferential outer corners of the lower and upper circumferential sidewalls 42, 44. In one embodiment, the width W of the groove 40 is suitably in the range of about 1.0 mm to about 5.0 mm and is more suitably about 3.0 mm. It is understood, however, that the groove 40 may be shaped and/or sized other than as set forth above without departing from the scope of the present invention.

As seen best in FIGS. 4 and 5, in the illustrated embodiment, an entirety of the groove 40 is spaced longitudinally above the shoulder 24 and below the external threads 28. As seen in FIG. 5, the lower circumferential sidewall 46 of the groove 40 (and hence the groove 40 itself) is spaced longitudinally from (i.e., above) the shoulder 24 a distance d1. The distance d1 in one embodiment is suitably greater than or at least equal to the width W of the groove 40. In another embodiment, the distance d1 may suitably be greater than about 1.0 mm (0.04 in), and in another embodiment, it may suitably be within a range of about 1.0 mm (0.04 in) to about 20 mm (0.80 in), even more suitably about 5.0 mm (0.20 in) to about 10.0 mm (0.40 in), and in the illustrated embodiment it is about 8.1 mm (0.32 in). Moreover, the upper circumferential sidewall 44 of the groove 40 is spaced longitudinally from (i.e., below) a lowermost turn of the threads 28 a distance d2. The distance d2 may suitably be greater than about 1.0 mm, and in one embodiment, it is more suitably about 4.1 mm (0.16 in). It is understood, however, that the longitudinal location of the groove 40 may be other than set forth above without departing from the scope of the present invention.

In one embodiment, the bottle 11 may be formed, such as by molding, as a one-piece component, and the cap 30 may be formed, such as by molding, as a separate one-piece component. Each of the bottle 11 and the cap 30 may be formed from plastic, including, but not limited to, polyethylene terephthalate (PETE), high density polyethylene (HDPE), low density polyethylene (LDPE), polyvinyl chloride (PVC), polypropylene, polysterene (PS), and polycarbonates. It is understood, however, that the bottle packaging 10 may be formed in other suitable ways and from other suitable materials.

Referring now to FIG. 6, the illustrated bottle 11 can be used, in one example, in combination with a tubing set, generally indicated at 47, by threading an adapter 48 of the tubing set onto the threaded neck 22 of the bottle. Because the neck 22 has a groove 40, as opposed to a radially projecting ring, the user will not pinch his/her finger(s) between the adapter and a projection when threading the adapter 48 onto the bottle 11. The tubing set 47 may be, for example, an enteral feeding set. The adapter 48 is fluidly connectable to a drip chamber 50, which is fluidly connected to suitable tubing 52. The adapter 48 includes one or more internal threads 53 (FIG. 7) for threaded connection with the threads 28 on the bottle 11 after the cap 30 is removed from the bottle 11. When secured to the bottle 11, a lowermost rim 48a of the adapter 48 is suitably spaced a distance d3 from the upper circumferential sidewall 44 of the groove 40 so that the adapter does not cover any portion of the groove. In one embodiment, the distance d3 is suitably greater than about 0.5 mm (0.02 in), and in another embodiment, the distance is suitably within a range of about 1.0 mm (0.04 in) to about 5.0 mm (0.2 in), and more suitably, about 1.8 mm (0.07 in). It is understood, however, that the adapter 48 may partially or completely cover the groove 40 upon connection to the bottle 11 without departing from the scope of the present invention.

As illustrated in the longitudinal section of FIG. 7, in one embodiment, as the adapter 48 is threaded onto the bottle 11, a blade member 54 of the adapter creates an opening in the seal closure 36 so that the adapter 48 fluidly connects the contents of the bottle with the drip chamber 50 and the feeding tube 52. The adapter 48 includes an air vent 55 and a microbial filter 55a attached thereto to vent the interior of the bottle 11 to the atmosphere so that the contents of the bottle can flow into the feeding tube 52 by gravity when the bottle is in an inverted, elevated position. It is contemplated that in other embodiments the adapter 48 may not include an air vent and/or a microbial filter. Moreover, the tubing set 47, including the adapter 48, may be configured other than as illustrated without departing from the scope of the present invention.

With reference now to FIGS. 8-9, one embodiment of a suitable holder for use in hanging the bottle 11 in an elevated, inverted position for administrating the contents of the bottle is generally indicated at 56. The holder 56 is in the form of a bag sized and shaped to receive the bottle 11 therein. It is understood that the holder 56 may have a different configuration without departing from the scope of the present invention. When the bag holder 56 is hung on an elevated support 57, such as an enteral feeding pole or an IV pole or other pole, the bottle 11 is retained in the bag holder in an inverted position. The bag holder 56 has an open top 58 through which the bottle 11 can be inserted into and removed from the bag. A bottom 59 of the bag has an opening 60 through which at least a portion of the neck 22 of the bottle 11 extends when the bottle is received in the bag. Because the neck of the bottle 11 has a groove 40, as opposed to a radially projecting ring, the neck can be more easily maneuvered through the opening 60 in the bag holder 56. The opening 60 is also sized and shaped to inhibit the shoulder 24 of the bottle packaging 10 from passing therethrough. The bag holder 56 has at least one mount opening 64 generally adjacent to the open top 58 that is adapted to receive a hook 66 or other attachment component of the elevated support 57 so that the bag can be hung on the elevated support in an inverted position. Together, the bottle 11, the adapter 48, and the holder 56 broadly define a flowable product delivery assembly, generally indicated at 68.

In the illustrated embodiment, the bag holder 56 is defined by a pair of opposing panels that are secured to one another, such as by heat welding, along opposite sides and bottom edges, and are free from attachment at top edges thereof. The opposing panels may be plastic panels that are heat weldable. The opening 60 extends through the bottom edges of the panels. Other ways of forming the bag holder 56, however, do not depart from the scope of the present invention.

In the embodiment illustrated in FIG. 10, another holder for use in hanging the bottle 11 in an elevated, inverted position for administrating the contents of the bottle is generally indicated at 70. The holder 70 comprises a back plate 72, a lower support member 74 extending forward from a lower portion of the back plate, an upper hanger member 76 extending upward from an upper portion of the back plate, and a pair of spaced apart, opposing arms 78 extending forward from opposite sides of the back plate. The arms 78 are configured to elastically deflect outward when the body 26 of the bottle 11 is inserted therebetween to removably retain the bottle on the holder 70. Other ways of removably retaining the bottle 11 on the holder 70 do not depart from the scope of the present invention. When the bottle 11 is secured to the holder 70, the adapter 48 rests on the support member 74. The hanger member 76 includes a mount opening 82 through which the hook 66 of the support 57 may be inserted to hang the bottle 11 in an inverted, elevated position. The holder 70 may be formed from a generally rigid plastic material, such as by molding, as a single, one-piece member.

Referring to FIG. 11, another embodiment of a bottle packaging is generally indicated at 110. This second embodiment is similar to the first embodiment, with like components indicated by corresponding reference numbers plus 100. The bottle 111 of the packaging 110 of this embodiment does not include threads. The removable cap 130 also does not include threads. Instead, the cap 130 includes a catch or detent 131 on the inner surface of the securement component 132. The detent 131 may comprise a single detent member, such as an annular detent member (as illustrated), or a plurality of detent members. The detent 131 is configured for releasably engaging the groove 140 to resist relative movement of the cap 130 on the bottle 111. In the illustrated embodiment, the detent 131 is resiliently deflectable so that the detent engages or locks in the groove 140 when a sufficient amount of downward force is applied to the cap 130 and disengages or releases from the groove when a sufficient amount of upward force is applied to the cap. In one embodiment, the detent 131 and the groove 140 make a snap-fit connection, whereby a clicking or snapping sound is made when the detent engages the groove to provide indication to the user that the cap 130 is properly connected to the bottle. The cap 130, or at least a portion thereof (i.e., the skirt), may also be transparent to allow the user or other person to visually confirm that the detent 131 is seated in the groove 140 and the cap is properly connected to the bottle. It is understood that the detent 131 may be configured other than as illustrated without departing from the scope of the present invention.

Referring to FIG. 12, another embodiment of an adapter is generally indicated at 148. The adapter 148 is similar to the adapter 48 of the previous embodiment (FIGS. 6 and 7), with like components indicated by corresponding reference numbers plus 100. The adapter 148 is configured for removable attachment to the bottle 111 illustrated in FIG. 11. As such, this embodiment of the adapter 148 does not include threads, but instead includes a catch or detent 149 on its inner surface that is configured to lock or engage in the groove 140 of the bottle 111. The detent 149 may comprise a single detent member, such as an annular detent member (as illustrated), or a plurality of detent members. The detent 149 may be similar in structure and function as the detent 131 on the cap 130. More specifically, the detent 149 may be resiliently deflectable so that the detent engages or locks in the groove 140 when a sufficient amount of downward force is applied to the adapter 148 and disengages or releases from the groove 140 of the neck 122 when a sufficient amount of upward force is applied to the adapter. In one embodiment, the detent 149 and groove 140 make a snap-fit connection, whereby a clicking or snapping sound is made when the detent engages the groove. The adapter 148, or at least a portion thereof (i.e., the skirt), may also be transparent to allow the user or other person to visually confirm that the detent 149 is seated in the groove 140 and the adapter is properly connected to the bottle. The detent 149 may in other embodiments be configured different from the detent 131 of the cap 130.

Referring to FIG. 13, another embodiment of bottle packaging is generally indicated at 210 and is similar to the embodiment illustrated in FIGS. 1-7, with like components indicated by corresponding reference numbers plus 200. One difference between the two embodiments is that the cap 230 of the present embodiment additionally includes an annular gasket 231, e.g., an O-ring (broadly, a sealing member) attached to the inner surface of the securement component 232. The gasket 231 is sized and shaped to seat in the groove 240 of the bottle 211 when the cap 230 is secured to the bottle 211. The gasket 231 may be formed from an elastically deformable (e.g., elastically compressible) material, and may be formed separate from the cap 230 and secured thereto such as by adhesive. Other ways of forming and providing the gasket 231 on the inner surface of the cap 230 are also contemplated to be within the scope of the present invention.

FIG. 14 illustrates yet another embodiment of the bottle packaging, generally indicated at 310, that is similar to the embodiment of FIGS. 1-7, with like components indicated by corresponding reference numbers plus 300. In this embodiment, the cap 330 includes a catch or detent 331 on the inner surface of the securement component 332. The detent 331 may comprise a single detent member, such as an annular detent member (as illustrated), or a plurality of detent members. The detent 331 is configured to releasably lock or engage the groove 340 of the neck 322 to resist relative movement of the cap closure 330 on the bottle packaging 310. In the illustrated embodiment, the detent 331 is resiliently deflectable so that the detent engages or locks in the groove 340 when a sufficient amount of downward force is applied to the cap closure 330 and disengages or releases from the groove 340 when a sufficient amount of upward force is applied to the cap closure. In one embodiment, the detent 331 and groove 340 make a snap-fit connection, whereby a clicking or snapping sound is made when the detent engages the groove to provide indication to the user that the cap is properly connected to the bottle.

As various changes could be made in the above constructions and methods without departing from the scope of the invention, it is intended that all matter contained in the above description and shown in the accompanying drawings shall be interpreted as illustrative and not in a limiting sense.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

What is claimed is:

1. A bottle packaging comprising:
a bottle comprising a body having an upper end and a closed lower end, a shoulder disposed generally at the upper end of the body, a neck extending up from the shoulder and defining an open top of the bottle, the neck having an inner surface, an outer surface and a groove in the outer surface of the neck, the groove extending circumferentially about substantially an entire circumference of the neck and being disposed longitudinally intermediate the shoulder of the bottle and the open top of the bottle, said groove having an upper reach and a lower reach and a width extending between the upper and lower reaches, the lower reach of the groove being longitudinally spaced from the shoulder of the bottle a distance of greater than or equal to the width of the groove, wherein the neck includes a lower portion extending from the lower reach of the groove to the shoulder of the bottle and an upper portion extending from the open top of the bottle to the upper reach of the groove, the upper and lower portions of the neck each having an outer transverse cross-sectional dimension wherein the outer transverse cross-sectional dimension of the upper portion is substantially equal to the outer transverse cross-sectional dimension of the lower portion; and
a closure member releasably connectable with the neck of the bottle to close the open top of the bottle.

2. The bottle packaging set forth in claim 1 wherein the lower reach of the groove is longitudinally spaced from the shoulder of the bottle a distance in the range of about 4.0 mm to about 10.0 mm.

3. The bottle packaging set forth in claim 1 wherein the closure member and the neck of the bottle are configured for threaded connection of the closure member on the neck of the bottle.

4. The bottle packaging set forth in claim 1 in combination with a delivery assembly configured for delivering contents from the bottle, the delivery assembly comprising an adapter and a tube assembled with the adapter, the adapter defining a closure member of the delivery assembly for releasably connecting the feeding tube assembly to the bottle with the closure member of the bottle packaging removed from the bottle, the adapter of the delivery assembly having a lower rim wherein the lower rim of the adapter is in longitudinally spaced relationship with the upper reach of the groove intermediate said upper reach and the top of the bottle when the adapter is connected to the bottle.

5. The bottle packaging set forth in claim 4 wherein the lower rim of the adapter is longitudinally spaced from the upper reach of the groove a distance of at least about 0.5 mm when the adapter is connected to the bottle.

6. The bottle packaging set forth in claim 1 wherein the closure member includes a detent on an inner surface thereof and removably seated in the groove of the neck of the bottle.

7. The bottle packaging set forth in claim 6 wherein the neck of the bottle is free from threads.

8. The bottle packaging set forth in claim 1 wherein the closure member includes a sealing member on an inner surface thereof and removably seated in the groove of the neck of the bottle.

9. A bottle packaging comprising:
a bottle comprising a body having an upper end and a closed lower end, a shoulder disposed generally at the upper end of the body, a neck extending up from the shoulder and defining an open top of the bottle, the neck having an inner surface, an outer surface and a groove in the outer surface of the neck, the groove extending circumferentially about substantially an entire circumference of the neck and being disposed longitudinally intermediate the shoulder of the bottle and the open top of the bottle, the groove being defined by a circumferential floor and opposing upper and lower circumferential sidewalls, wherein the upper circumferential sidewall is chamfered from adjacent the outer surface of the neck toward the circumferential floor, and the lower circumferential sidewall is concave from adjacent the outer surface of the neck toward the circumferential floor, the lower circumferential sidewall being spaced longitudinally above the shoulder a distance of at least about 1.0 mm; and
a closure member releasably connectable with the neck of the bottle to close the open top of the bottle.

10. The bottle packaging set forth in claim 9 wherein the lower reach of the groove is longitudinally spaced from the shoulder of the bottle a distance in the range of about 5.0 mm to about 10.0 mm.

11. The bottle packaging set forth in claim 9 wherein the neck includes a lower portion extending from the lower reach of the groove to the shoulder of the bottle and an upper portion extending from the open top of the bottle to the upper reach of the groove, the upper and lower portions of the neck each having an outer transverse cross-sectional dimension wherein the outer transverse cross-sectional dimension of the upper portions is substantially equal to the outer transverse cross-sectional dimension of the lower portion.

12. The bottle packaging set forth in claim 9 wherein the closure member and the neck of the bottle are configured for threaded connection of the closure member on the neck of the bottle.

13. The bottle packaging set forth in claim 9 in combination with a delivery assembly configured for delivering contents from the inner of the bottle, the delivery assembly comprising an adapter and a tube assembled with the adapter, the adapter defining a closure member of the delivery assembly for releasably connecting the feeding tube assembly to the bottle with the closure member of the bottle packaging removed from the bottle, the adapter of the delivery assembly having a lower rim wherein the lower rim of the adapter is in longitudinally spaced relationship with the upper reach of the groove intermediate said upper reach and the top of the bottle when the adapter is connected to the bottle.

14. The bottle packaging set forth in claim 13 wherein the lower rim of the adapter is longitudinally spaced from the upper reach of the groove a distance of at least about 0.5 mm when the adapter is connected to the bottle.

15. The bottle packaging set forth in claim 9 wherein the closure member includes a detent on an inner surface thereof and removably seated in the groove of the neck of the bottle.

16. The bottle packaging set forth in claim 15 wherein the neck of the bottle is free from threads.

17. The bottle packaging set forth in claim 9 wherein the closure member includes a sealing member on an inner surface thereof and removably seated in the groove of the neck of the bottle.

18. A flowable product delivery assembly comprising:
a bottle having a longitudinal axis, the bottle including a neck having an outer surface and a groove in said outer surface extending circumferentially around substantially an entire circumference of the neck, the groove having an upper reach and a lower reach;
an adapter removably connected to the neck of the bottle by a threaded connection to fluidly connect the bottle to tubing, wherein the adapter includes a lowermost rim spaced longitudinally from the upper reach of the groove.

19. The assembly set forth in claim 18 wherein the lowermost rim of the adapter is spaced longitudinally from the upper reach of the groove a distance of at least about 0.5 mm.

20. The assembly set forth in claim 18 wherein the lowermost rim of the adapter is spaced longitudinally from the upper reach of the groove a distance within a range of about 1.0 mm to about 5.0 mm.

21. A flowable product delivery assembly comprising:
a bottle having a longitudinal axis, the bottle including a neck having an outer surface and a groove in said outer surface extending circumferentially around substantially an entire circumference of the neck,
an adapter configured for releasable connection to the bottle to fluidly connect the bottle to tubing, wherein the adapter includes a detent on an inner surface thereof adapted to removably seat in the groove to releasably connect the adapter to the bottle.

22. The assembly set forth in claim 21 wherein the detent of the adapter is adapted to resiliently deform as it seats in the groove.

23. The assembly set forth in claim 22 wherein the neck of the bottle is free from threads.

24. The assembly set forth in claim 21 further comprising a holder for use in hanging the bottle in an elevated, inverted position.

25. The assembly set forth in claim 21 wherein at least a portion of the adapter is transparent to provide for visual confirmation that the detent is seated in the groove when the adapter is connected to the bottle.

26. A bottle packaging comprising:
a bottle comprising a body having an upper end and a closed lower end, a shoulder disposed generally at the upper end of the body, a neck extending up from the shoulder and defining an open top of the bottle, the neck having an inner surface, an outer surface, at least one thread on the outer surface of the neck, and a groove in the outer surface of the neck, the groove extending circumferentially about substantially an entire circumference of the neck and being disposed longitudinally intermediate the shoulder of the bottle and said at least one thread on the outer surface of the neck, and
a closure member removably threaded on said at least one thread on the outer surface of the neck of the bottle to close the open top of the bottle, the closure member including at least one of a detent and a sealing member removably seated in the groove of the neck of the bottle.

27. The bottle packaging set forth in claim 26 wherein said at least one of a detent and a sealing member consists of a detent.

28. The bottle packaging set forth in claim 27 wherein the detent and the groove are adapted for snap-fit connection, whereby a clicking or snapping sound is made upon the detent seating in the groove.

29. The bottle packaging set forth in claim 26 wherein at least a portion of the closure member is transparent to provide for visual confirmation that the least one of a detent and a sealing member is seated in the groove of the neck of the bottle.

30. The bottle packaging set forth in claim 26 wherein said at least one of a detent and a sealing member consists of a sealing member.

31. The bottle packaging set forth in claim 29 wherein the sealing member comprises an O-ring.
